(19) United States
(12) Patent Application Publication
(10) Pub. No.: US 2025/0326170 A1
(43) Pub. Date: Oct. 23, 2025

(54) MOLDED ARTICLE MANAGEMENT APPARATUS

(71) Applicant: SUMITOMO HEAVY INDUSTRIES, LTD., Tokyo (JP)

(72) Inventor: Tomosuke KADOONO, Chiba (JP)

(21) Appl. No.: 19/083,945

(22) Filed: Mar. 19, 2025

(30) Foreign Application Priority Data
Apr. 22, 2024 (JP) 2024-068836

(51) Int. Cl. B29C 45/76

(52) U.S. Cl. CPC B29C 45/76; B29C 2945/7613; B29C 2945/76939

(57) ABSTRACT

A molded article management apparatus includes a processor; and a memory storing instructions that cause the processor to execute a process, wherein the process includes storing identification information of each molded article manufactured by an injection molding machine in association with a material loss amount per molded article manufactured during a set period. The material loss amount is an amount of resin that does not become the molded article, of an amount of resin injected from the injection molding machine during the set period, and the storing includes dividing the material loss amount into a waste amount and a recycle amount and storing the waste amount and the recycle amount.

### CROSS-REFERENCE TO RELATED APPLICATIONS

This application is based upon and claims priority to Japanese Patent Application No. 2024-068836 filed on Apr. 22, 2024, the entire contents of which are incorporated herein by reference.

### BACKGROUND

### 1. Technical Field

The present disclosure relates to a molded article management apparatus.

### 2. Description of Related Art

An example of the related art technology discloses a material loss management system that includes a material loss amount calculation part for calculating a material loss amount generated in a molding machine, a factor specification part for specifying a material loss generation factor, an aggregation period input device for inputting an aggregation period, a material loss aggregation means for aggregating the material loss amount over the aggregation period, and an aggregation result output device for outputting an aggregation result of the material loss amount.

Another example of the related art technology discloses display of information such as the operation rate, power consumption, resin consumption, non-defective rate, defective rate, and operation time of the entire injection molding machine. In addition, this related art technology discloses calculation of the in-molding-process defect rate, the inspection defect rate, and the material defect rate. Further, his related art technology discloses that in calculating the non-defective rate, the weight of material that has been discarded and the weight of molded articles that have been discarded before molding stabilizes at the start of the molding process may be added to the sum of the weight of good products and the weight of defective products.

### SUMMARY

According to one embodiment of the present disclosure, a molded article management apparatus is provided. The molded article management apparatus includes:
a processor; and
a memory storing instructions that cause the processor to execute a process, the process including
storing identification information of each molded article manufactured by an injection molding machine in association with a material loss amount per molded article manufactured during a set period, wherein
the material loss amount is an amount of resin that does not become the molded article, of an amount of resin injected from the injection molding machine during the set period, and
the storing includes dividing the material loss amount into a waste amount and a recycle amount and storing the waste amount and the recycle amount.

### BRIEF DESCRIPTION OF THE DRAWINGS

FIG. 1 is a view illustrating a state of an injection molding machine according to an embodiment when mold opening is completed.

FIG. 2 is a view illustrating a state of the injection molding machine according to the embodiment when the mold is clamped.

FIG. 3 is a flowchart illustrating examples of factors causing a material loss from start-up to shut-down of the injection molding machine.

FIG. 4 is a functional block diagram illustrating examples of components of a molded article management apparatus.

FIG. 5 is a table illustrating examples of data stored in a data storage part.

FIG. 6 is a table illustrating examples of a set period that can be adopted according to factors.

### DETAILED DESCRIPTION

In the related art technologies, calculation of the material loss amount generated during the process of manufacturing molded articles has been studied. The material loss amount is an amount of resin that does not become a molded article (more specifically, a defect-free article), of an amount of resin injected from the injection molding machine. The material loss is caused by purging at the start-up of the injection molding machine, generation of trial shots at the adjustment of molding conditions, generation of waste shots at the start of mass production, generation of by-products at the mass production, generation of defective products at the mass production, generation of waste shots at the restart of mass production, purging at the shut-down of the injection molding machine, and the like.

Part of the resin injected from the injection molding machine that has not been molded into a molded article may be crushed by a crusher or the like and recycled as a molding material. Therefore, the material loss amount does not necessarily correspond to the waste amount. Therefore, in the related art technologies, the waste amount could not be accurately controlled. As a result, for example, the CO₂ emissions in Scope 3 Category 5 as defined in the GHG (Greenhouse Gas) Protocol could not be accurately calculated. The CO₂ emissions in Scope 3 Category 5 of are CO₂ emissions that can be reduced by reviewing the operation of injection molding machines.

According to an embodiment of the present disclosure, a technique capable of accurately managing the waste amount of resin is provided.

According to one embodiment of the disclosure, it is possible to accurately control the waste amount of resin.

Hereinafter, an embodiment of the present disclosure will be described with reference to the accompanying drawings. In the drawings, the same or corresponding components are denoted by the same reference numerals, and the description thereof may be omitted.

### Injection Molding Machine

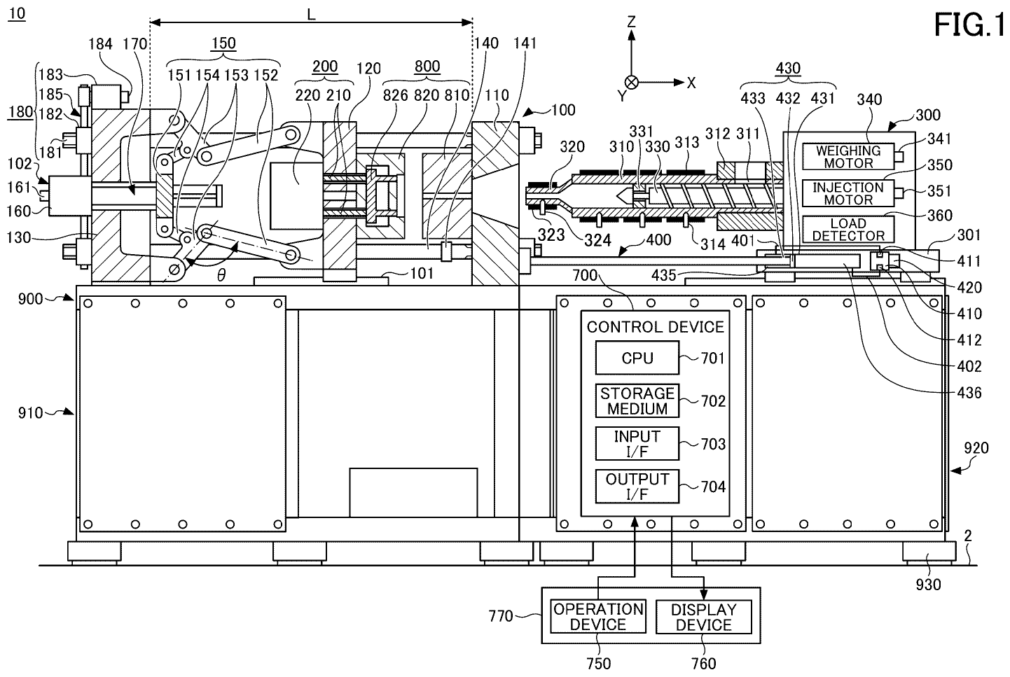

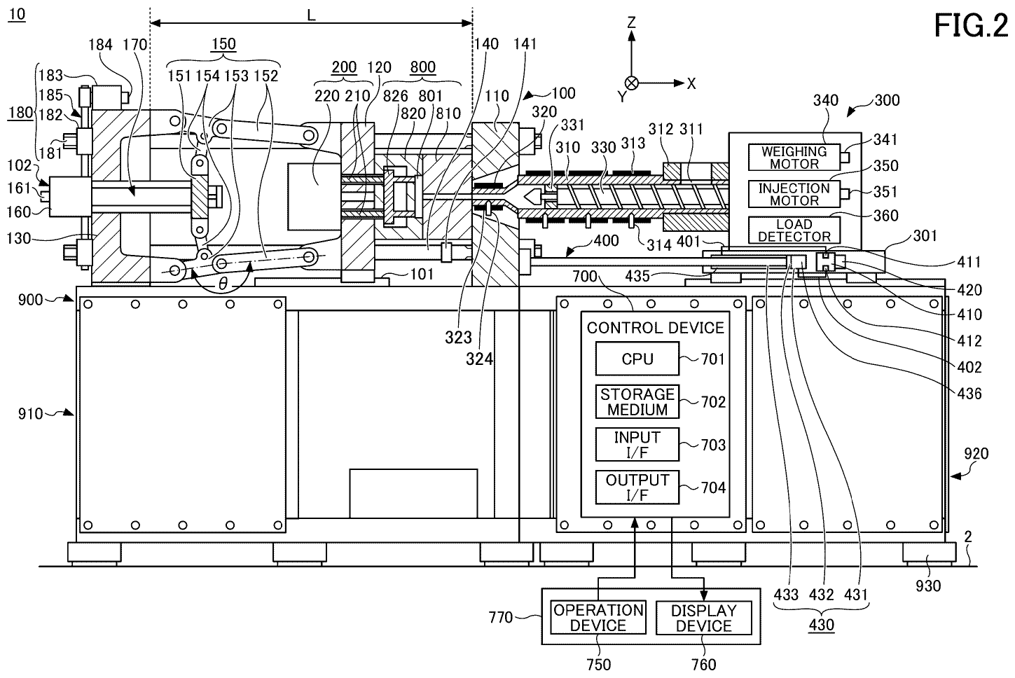

FIG. 1 is a view illustrating a state of an injection molding machine according to an embodiment when mold opening is completed. FIG. 2 is a diagram illustrating a state of the injection molding machine according to the embodiment when the mold is clamped. In the present specification, the X-axis direction, the Y-axis direction, and the Z-axis direction are directions perpendicular to each other. The X-axis direction and the Y-axis direction represent a horizontal direction, and the Z-axis direction represents a vertical direction. When a mold clamping device 100 is a horizontal type, the X-axis direction is a mold opening-closing direction, and the Y-axis direction is a width direction of the injection molding machine 10. The negative side in the Y-axis direction is called the operation side, and the positive side in the Y-axis direction is called the anti-operation side.

As illustrated in FIGS. 1 and 2, the injection molding machine 10 includes the mold clamping device 100 that opens and closes a mold device 800, an ejector device 200 that ejects a molded article molded by the mold device 800, an injection device 300 that injects a molding material into the mold device 800, a moving device 400 that moves the injection device 300 forward and backward with respect to the mold device 800, a control device 700 that controls each component of the injection molding machine 10, and a frame 900 that supports each component of the injection molding machine 10. The frame 900 includes a mold clamping device frame 910 that supports the mold clamping device 100 and an injection device frame 920 that supports the injection device 300. The mold clamping device frame 910 and the injection device frame 920 are installed on a floor 2 via leveling adjusters 930 and, respectively. The control device 700 is disposed in an internal space of the injection device frame 920. Hereinafter, each component of the injection molding machine 10 will be described.

### Mold Clamping Device

In the description of the mold clamping device 100, a moving direction (e.g., an X-axis positive direction) of a movable platen 120 at the time of mold closing is referred to as a front side, and a moving direction (e.g., an X-axis negative direction) of the movable platen 120 at the time of mold opening is referred to as a rear side.

The mold clamping device 100 performs mold closing, pressure increasing, mold clamping, pressure decreasing, and mold opening of the mold device 800. The mold device 800 includes a fixed mold 810 and a movable mold 820.

The mold clamping device 100 is, for example, a horizontal type, and the mold opening-closing direction is a horizontal direction. The mold clamping device 100 includes a fixed platen 110 to which the fixed mold 810 is attached, a movable platen 120 to which the movable mold 820 is attached, and a moving mechanism 102 that moves the movable platen 120 in the mold opening-closing direction with respect to the fixed platen 110.

The fixed platen 110 is fixed to the mold clamping device frame 910. The fixed mold 810 is attached to a surface of the fixed platen 110 facing the movable platen 120.

The movable platen 120 is disposed so as to be movable in the mold opening-closing direction with respect to the mold clamping device frame 910. A guide 101 for guiding the movable platen 120 is laid on the mold clamping device frame 910. The movable mold 820 is attached to a surface of the movable platen 120 facing the fixed platen 110.

The moving mechanism 102 moves the movable platen 120 forward and backward with respect to the fixed platen 110 to perform mold closing, pressure increasing, mold clamping, pressure decreasing, and mold opening of the mold device 800. The moving mechanism 102 includes a toggle support 130 disposed at a distance from the fixed platen 110, tie bars 140 connecting the fixed platen 110 and the toggle support 130, a toggle mechanism 150 moving the movable platen 120 in the mold opening-closing direction with respect to the toggle support 130, a mold clamping motor 160 operating the toggle mechanism 150, a motion conversion mechanism 170 converting the rotational motion of the mold clamping motor 160 into linear motion, and a mold thickness adjustment mechanism 180 adjusting the distance between the fixed platen 110 and the toggle support 130.

The toggle support 130 is disposed with the distance from the fixed platen 110 and is placed on the mold clamping device frame 910 so as to be movable in the mold opening-closing direction. The toggle support 130 may be disposed so as to be movable along a guide laid on the mold clamping device frame 910. The guide of the toggle support 130 may be common to the guide 101 of the movable platen 120.

In the present embodiment, the fixed platen 110 is fixed to the mold clamping device frame 910, and the toggle support 130 is disposed so as to be movable in the mold opening-closing direction with respect to the mold clamping device frame 910, but the toggle support 130 may be fixed to the mold clamping device frame 910, and the fixed platen 110 may be disposed so as to be movable in the mold opening-closing direction with respect to the mold clamping device frame 910.

The tie bars 140 connect the fixed platen 110 and the toggle support 130 with a distance L therebetween the mold opening-closing direction. A plurality of (e.g., four) tie bars 140 may be used. The plurality of tie bars 140 are arranged in parallel in the mold opening-closing direction and extend in response to the mold clamping force. A tie bar strain detector 141 that detects strain of the tie bar 140 may be provided on at least one tie bar 140. The tie bar strain detector 141 sends a signal indicating a detection result to the control device 700. The detection result of the tie bar strain detector 141 is used for detection of the mold clamping force and the like.

In the present embodiment, the tie bar strain detector 141 is used as a mold clamping force detector that detects the mold clamping force, but the present disclosure is not limited thereto. The mold clamping force detector is not limited to a strain detector type, and may be a piezoelectric type, a capacitance type, a hydraulic type, an electromagnetic type, or the like, and the attachment position of the mold clamping force detector is not limited to the tie bar 140.

The toggle mechanism 150 is disposed between the movable platen 120 and the toggle support 130, and moves the movable platen 120 in the mold opening-closing direction with respect to the toggle support 130. The toggle mechanism 150 includes a crosshead 151 that moves in the mold opening-closing direction, and a pair of link groups that bend and stretch by the movement of the crosshead 151. The pair of link groups each include a first link 152 and a second link 153 which are connected to each other by a pin or the like so as to be bendable and stretchable. The first link 152 is swingably attached to the movable platen 120 by a pin or the like. The second link 153 is swingably attached to the toggle support 130 by a pin or the like. The second link 153 is attached to the crosshead 151 via a third link 154. When the crosshead 151 is moved forward and backward with respect to the toggle support 130, the first link 152 and the second link 153 are bent and stretched, and the movable platen 120 is moved forward and backward with respect to the toggle support 130.

The configuration of the toggle mechanism 150 is not limited to the configuration illustrated in FIGS. 1 and 2. For example, in FIGS. 1 and 2, the number of nodes of each link group is five, but may be four, and one end of the third link 154 may be coupled to the node between the first link 152 and the second link 153.

The mold clamping motor 160 is attached to the toggle support 130 and operates the toggle mechanism 150. The mold clamping motor 160 moves the crosshead 151 forward and backward with respect to the toggle support 130 to bend and stretch the first link 152 and the second link 153, and moves the movable platen 120 forward and backward with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts the rotational motion of the mold clamping motor 160 into the linear motion of the crosshead 151. The motion conversion mechanism 170 includes a screw shaft and a screw nut screwed to the screw shaft. Balls or rollers may be interposed between the screw shaft and the screw nut.

The mold clamping device 100 performs a mold closing step, a pressure increasing step, a mold clamping step, a pressure decreasing step, a mold opening step, and the like under the control of the control device 700.

In the mold closing step, the mold clamping motor 160 is driven to move the crosshead 151 forward to a mold closing completion position at a set moving speed, thereby advancing the movable platen 120 and causing the movable mold 820 to touch the fixed mold 810. The position and the moving speed of the crosshead 151 are detected by using, for example, a mold clamping motor encoder 161. The mold clamping motor encoder 161 detects the rotation of the mold clamping motor 160 and sends a signal indicating the detection result to the control device 700.

A crosshead position detector that detects the position of the crosshead 151 and a crosshead moving speed detector that detects the moving speed of the crosshead 151 are not limited to the mold clamping motor encoder 161, and general detectors can be used. Further, a movable platen position detector that detect the position of the movable platen 120 and a movable platen moving speed detector that detect the moving speed of the movable platen 120 are not limited to the mold clamping motor encoder 161, and general detectors can be used.

In the pressure increasing step, the mold clamping force is generated by further driving the mold clamping motor 160 to further move the crosshead 151 forward from the mold closing completion position to the mold clamping position.

In the mold clamping step, the mold clamping motor 160 is driven to maintain the position of the crosshead 151 at the mold clamping position. In the mold clamping step, the mold clamping force generated in the pressure increasing step is maintained. In the mold clamping step, a cavity space 801 (see FIG. 2) is formed between the movable mold 820 and the fixed mold 810, and the injection device 300 fills the cavity space 801 with a liquid molding material. The filled molding material is solidified to obtain a molded article.

The number of cavity spaces 801 may be one or more. In the latter case, a plurality of molded articles are obtained simultaneously. An insert material may be disposed in a part of the cavity space 801, and another part of the cavity space 801 may be filed with a molding material. A molded article in which the insert material and the molding material are integrated is obtained.

In the pressure decreasing step, the movable platen 120 is moved backward by driving the mold clamping motor 160 to move the crosshead 151 backward from the mold clamping position to the mold opening start position, and the mold clamping force is reduced. The mold opening start position and the mold closing completion position may be the same position.

In the mold opening step, the movable platen 120 is moved backward by driving the mold clamping motor 160 to move the crosshead 151 backward from the mold opening start position to the mold opening completion position at a set moving speed, and the movable mold 820 is separated from the fixed mold 810. Thereafter, the ejector device 200 ejects the molded article from the movable mold 820.

The setting conditions in the mold closing step, the pressure increasing step, and the mold clamping step are collectively set as a series of setting conditions. For example, the moving speed and positions (including the mold closing start position, moving speed switching position, completion position, and mold clamping mold closing position) of the crosshead 151 in the mold closing step and the pressure increasing step, and the mold clamping force are collectively set as a series of setting conditions. The mold closing start position, the moving speed switching position, the mold closing completion position, and the mold clamping position are arranged in this order from the rear side to the front side, and represent a start point or an end point of a section in which a moving speed is set. The moving speed is set for each section. The number of the moving speed switching positions may be one or more. The moving speed switching position may not be set. Only one of the mold clamping position and the mold clamping force may be set.

The setting conditions in the pressure decreasing step and the mold opening step are set in the same manner. For example, the moving speed and position (the mold opening start position, the moving speed switching position, and the mold opening completion position) of the crosshead 151 in the pressure decreasing step and the mold opening step are collectively set as a series of setting conditions. The mold opening start position, the moving speed switching position, and the mold opening completion position are arranged in this order from the front side to the rear side, and represent a start point or an end point of a section in which a moving speed is set. The moving speed is set for each section. The number of the moving speed switching positions may be one or more. The moving speed switching position may not be set. The mold opening start position and the mold closing completion position may be the same position. The mold opening completion position and the mold closing start position may be the same position.

Instead of the moving speed and the position of the crosshead 151, the moving speed and position of the movable platen 120 may be set. Further, instead of the position of the crosshead (e.g., the mold clamping position) or the position of the movable platen, the mold clamping force may be set.

The toggle mechanism 150 amplifies the driving force of the mold clamping motor 160 and transmits the amplified driving force to the movable platen 120. The amplification factor is also called a toggle magnification. The toggle magnification changes according to an angle θ formed by the first link 152 and the second link 153 (hereinafter, also referred to as a “link angle θ”). The link angle θ is obtained from the position of the crosshead 151. When the link angle θ is 180°, the toggle magnification is maximized.

When the thickness of the mold device 800 changes due to the replacement of the mold device 800 or the temperature change of the mold device 800, the mold thickness is adjusted so that a predetermined mold clamping force is obtained at the time of mold clamping. In the mold thickness adjustment, for example, a distance L between the fixed platen 110 and the toggle support 130 is adjusted so that the link angle θ of the toggle mechanism 150 becomes a predetermined angle at the time of mold touch at which the movable mold 820 touches the fixed mold 810.

The mold clamping device 100 includes a mold thickness adjustment mechanism 180. The mold thickness adjustment mechanism 180 adjusts the mold thickness by adjusting the distance L between the fixed platen 110 and the toggle support 130. The mold thickness is adjusted at a timing, for example, between the end of a molding cycle and the start of a next molding cycle. The mold thickness adjustment mechanism 180 includes, for example, a screw shaft 181 formed at the rear end of the tie bar 140, a screw nut 182 held by the toggle support 130 in a rotatable and non-retractable manner, and a mold thickness adjustment motor 183 that rotates the screw nut 182 screwed to the screw shaft 181.

The screw shaft 181 and the screw nut 182 are provided for each tie bar 140. The rotational driving force of the mold thickness adjustment motor 183 may be transmitted to the plurality of screw nuts 182 via the rotational driving force transmission part 185. The plurality of screw nuts 182 can be rotated synchronously. Note that the plurality of screw nuts 182 can be individually rotated by changing the transmission path of the rotational driving force transmission part 185.

The rotational driving force transmission part 185 is configured by, for example, a gear. In this case, a driven gear is formed on the outer periphery of each screw nut 182, a driving gear is attached to the output shaft of the mold thickness adjustment motor 183, and an intermediate gear which meshes with a plurality of driven gears and the driving gear is rotatably held at the center of the toggle support 130. The rotational driving force transmission part 185 may be configured by a belt, a pulley, or the like instead of the gear.

The operation of the mold thickness adjustment mechanism 180 is controlled by the control device 700. The control device 700 drives the mold thickness adjustment motor 183 to rotate the screw nut 182. As a result, the position of the toggle support 130 with respect to the tie bar 140 is adjusted, and the distance L between the fixed platen 110 and the toggle support 130 is adjusted. A plurality of mold thickness adjustment mechanisms may be used in combination.

The distance L is detected by using a mold thickness adjustment motor encoder 184. The mold thickness adjustment motor encoder 184 detects the rotation amount and the rotation direction of the mold thickness adjustment motor 183, and sends a signal indicating the detection result to the control device 700. The detection result of the mold thickness adjustment motor encoder 184 is used for monitoring and controlling the position of the toggle support 130 and the distance L. The toggle support position detector that detects the position of the toggle support 130 and the distance detector that detects the distance L are not limited to the mold thickness adjustment motor encoder 184, and general detectors can be used.

The mold clamping device 100 may include a mold temperature regulator that regulates the temperature of the mold device 800. The mold device 800 has a flow path for a temperature control medium in the mold device 800. The mold temperature regulator regulates the temperature of the mold device 800 by regulating the temperature of the temperature regulating medium supplied to the flow path of the mold device 800.

The mold clamping device 100 of the present embodiment is a horizontal type in which the mold opening-closing direction is a horizontal direction, but may be a vertical type in which the mold opening-closing direction is a vertical direction.

The mold clamping device 100 of the present embodiment includes the mold clamping motor 160 as a driving part, but may include a hydraulic cylinder instead of the mold clamping motor 160. The mold clamping device 100 may include a linear motor for opening and closing the mold and an electromagnet for clamping the mold.

### Ejector Device

In the description of the ejector device 200, as in the description of the mold clamping device 100, the moving direction (e.g., the X-axis positive direction) of the movable platen 120 at the time of mold closing is described as the front side, and the moving direction (e.g., the X-axis negative direction) of the movable platen 120 at the time of mold opening is described as the rear side.

The ejector device 200 is attached to the movable platen 120 and moves forward and backward together with the movable platen 120. The ejector device 200 includes an ejector rod 210 that ejects a molded article from the mold device 800, and a drive mechanism 220 that moves the ejector rod 210 in the moving direction (X-axis direction) of the movable platen 120.

The ejector rod 210 is disposed in a through-hole of the movable platen 120 so as to be movable forward and backward. The front end of the ejector rod 210 is in contact with an ejector plate 826 of the movable mold 820. The front end of the ejector rod 210 may be connected to the ejector plate 826 or may not be connected to the ejector plate 826.

The drive mechanism 220 includes, for example, an ejector motor and a motion conversion mechanism that converts a rotational motion of the ejector motor into a linear motion of the ejector rod 210. The motion conversion mechanism includes a screw shaft and a screw nut screwed to the screw shaft. Balls or rollers may be interposed between the screw shaft and the screw nut.

The ejector device 200 performs the ejection step under the control of the control device 700. In the ejection step, the ejector rod 210 is moved forward from the standby position to the ejection position at a set moving speed, whereby the ejector plate 826 is moved forward to eject the molded article. Thereafter, the ejector motor is driven to move the ejector rod 210 backward at a set moving speed, and the ejector plate 826 is moved backward to the original standby position.

The position and the moving speed of the ejector rod 210 are detected by using, for example, an ejector motor encoder. The ejector motor encoder detects the rotation of the ejector motor and sends a signal indicating the detection result to the control device 700. The ejector rod position detector that detects the position of the ejector rod 210 and the ejector rod moving speed detector that detects the moving speed of the ejector rod 210 are not limited to the ejector motor encoder, and general detectors can be used.

### Injection Device

In the description of the injection device 300, unlike the description of the mold clamping device 100 and the description of the ejector device 200, the moving direction of the screw 330 during filling (e.g., the X-axis negative direction) is referred to as the front side, and the moving direction of the screw 330 during weighing (e.g., the X-axis positive direction) is referred to as the rear side.

The injection device 300 is installed on a slide base 301, and the slide base 301 is disposed so as to be movable forward and backward with respect to an injection device frame 920. The injection device 300 is disposed so as to be movable forward and backward with respect to the mold device 800. The injection device 300 touches the mold device 800 and fills the cavity space 801 inside the mold device 800 with the molding material. The injection device 300 includes, for example, a cylinder 310 that heats the molding material, a nozzle 320 provided at a front end of the cylinder 310, a screw 330 disposed in the cylinder 310 in a retractable and rotatable manner, a weighing motor 340 that rotates the screw 330, an injection motor 350 that moves the screw 330 forward and backward, and a load detector 360 that detects a load transmitted between the injection motor 350 and the screw 330.

The cylinder 310 heats the molding material supplied from a supply port 311 to the inside. The molding material includes, for example, a resin. The molding material is formed in a pellet shape, for example, and is supplied to the supply port 311 in a solid state. The supply port 311 is formed in a rear side of the cylinder 310. A cooler 312 such as a water-cooled cylinder is provided on the outer periphery of the rear side of the cylinder 310. A first heater 313 such as a band heater and a first temperature detector 314 are provided on the outer periphery of the cylinder 310 in front of the cooler 312.

The cylinder 310 is divided into a plurality of zones in the axial direction (e.g., the X-axis direction) of the cylinder 310. The first heater 313 and the first temperature detector 314 are provided in each of the plurality of zones. Each of the plurality of zones has a set temperature. The control device 700 controls the first heater 313 so that the temperature detected by the first temperature detector 314 becomes the set temperature.

The nozzle 320 is provided at the front end of the cylinder 310 and is pressed against the mold device 800. A second heater 323 and a second temperature detector 324 are provided on the outer periphery of the nozzle 320. The control device 700 controls the second heater 323 so that the detected temperature of the nozzle 320 becomes the set temperature.

The screw 330 is disposed in the cylinder 310 in a rotatable and retractable manner. When the screw 330 is rotated, the molding material is fed forward along the spiral groove of the screw 330. The molding material is gradually melted by the heat from the cylinder 310 while being fed forward. As the liquid molding material is fed to the front side of the screw 330 and accumulated in front of the cylinder 310, the screw 330 is moved backward. Thereafter, when the screw 330 is moved forward, the liquid molding material accumulated in front of the screw 330 is injected from the nozzle 320 thereby filling the mold device 800 with the liquid molding material.

A backflow prevention ring 331 is attached to the front side of the screw 330 so as to be movable forward and backward as a backflow prevention valve that prevents backflow of the molding material from the front side to the rear side of the screw 330 when the screw 330 is pushed forward.

When the screw 330 is moved forward, the backflow prevention ring 331 is pushed backward by the pressure of the molding material at the front side of the screw 330, and is moved backward relative to the screw 330 to a closing position (see FIG. 2) at which the flow path of the molding material is closed. This prevents the molding material accumulated in front of the screw 330 from flowing backward.

When the screw 330 is rotated, the backflow prevention ring 331 is pushed forward by the pressure of the molding material fed forward along the spiral groove of the screw 330, and moves forward relative to the screw 330 to an open position (see FIG. 1) at which the flow path of the molding material is opened. Thus, the molding material is fed to the front side of the screw 330.

The backflow prevention ring 331 may be either a co-rotation type that rotates together with the screw 330 or a non-co-rotation type that does not rotate together with the screw 330.

The injection device 300 may include a drive source that moves the backflow prevention ring 331 forward and backward between the open position and the closed position with respect to the screw 330.

The weighing motor 340 rotates the screw 330. The drive source that rotates the screw 330 is not limited to the weighing motor 340, and may be, for example, a hydraulic pump, or the like.

The injection motor 350 moves the screw 330 forward and backward. A motion conversion mechanism or the like that converts the rotational motion of the injection motor 350 into the linear motion of the screw 330 is provided between the injection motor 350 and the screw 330. The motion conversion mechanism includes, for example, a screw shaft and a screw nut screwed to the screw shaft. Balls, rollers, or the like may be provided between the screw shaft and the screw nut. The drive source that moves the screw 330 forward and backward is not limited to the injection motor 350, and may be, for example, a hydraulic cylinder.

The load detector 360 detects a load transmitted between the injection motor 350 and the screw 330. The detected load is converted into a pressure by the control device 700. The load detector 360 is provided in a load transmission path between the injection motor 350 and the screw 330, and detects a load acting on the load detector 360.

The load detector 360 sends a signal of the detected load to the control device 700. The load detected by the load detector 360 is converted into a pressure acting between the screw 330 and the molding material, and is used to control or monitor the pressure received by the screw 330 from the molding material, the back pressure to the screw 330, the pressure applied to the molding material from the screw 330, and the like.

The pressure detector that detects the pressure of the molding material is not limited to the load detector 360, and a general pressure detector can be used. For example, a nozzle pressure sensor or a mold internal pressure sensor may be used. The nozzle pressure sensor is installed in the nozzle 320. The mold internal pressure sensor is installed inside the mold device 800.

The injection device 300 performs a weighing step, a filling step, a pressure holding step, and the like under the control of the control device 700. The filling step and the pressure holding step may be collectively referred to as an injection step.

In the weighing step, the weighing motor 340 is driven to rotate the screw 330 at a set rotation speed, and the molding material is fed forward along the spiral groove of the screw 330. Accordingly, the molding material is gradually melted. As the liquid molding material is fed to the front side of the screw 330 and accumulated in front of the cylinder 310, the screw 330 is moved backward. The rotation speed of the screw 330 is detected by using, for example, a weighing motor encoder 341. The weighing motor encoder 341 detects the rotation of the weighing motor 340 and sends a signal indicating the detection result to the control device 700. The screw rotational speed detector that detects the rotational speed of the screw 330 is not limited to the weighing motor encoder 341, and a general detector can be used.

In the weighing step, in order to limit the rapid retraction of the screw 330, the injection motor 350 may be driven to apply a setback pressure to the screw 330. The back pressure to the screw 330 is detected by using, for example, the load detector 360. When the screw 330 is moved backward to the weighing completion position and a predetermined amount of the molding material is accumulated in front of the screw 330, the weighing step is completed.

The position and the rotation speed of the screw 330 in the weighing step are collectively set as a series of setting conditions. For example, a weighing start position, a rotational speed switching position, and a weighing completion position are set. These positions are arranged in this order from the front side to the rear side, and represent the start point or the end point of the section in which the rotation speed is set. The rotation speed is set for each section. The rotational speed switching position may be one or more. The rotational speed switching position may not be set. Further, the back pressure is set for each section.

In the filling step, the injection motor 350 is driven to move the screw 330 forward at a set moving speed, filling the cavity space 801 inside the mold device 800 with the liquid molding material accumulated in front of the screw 330. The position and the moving speed of the screw 330 are detected by using, for example, an injection motor encoder 351. The injection motor encoder 351 detects the rotation of the injection motor 350, and sends a signal indicating the detection result to the control device 700. When the position of the screw 330 reaches the set position, switching from the filling step to the pressure holding step (so-called V/P switching) is performed. A position at which V/P switching is performed is referred to as a V/P switching position. The set moving speed of the screw 330 may be changed according to the position of the screw 330, time, or the like.

The position and the moving speed of the screw 330 in the filling step are collectively set as a series of setting conditions. For example, the filling start position (also referred to as “injection start position”), the moving speed switching position, and the V/P switching position are set. These positions are arranged in this order from the rear side to the front side, and represent the start point or the end point of the section in which the moving speed is set. The moving speed is set for each section. The number of the moving speed switching positions may be one or more. The moving speed switching position may not be set.

The upper limit value of the pressure of the screw 330 is set for each section in which the moving speed of the screw 330 is set. The pressure of the screw 330 is detected by the load detector 360. When the pressure of the screw 330 is equal to or lower than the set pressure, the screw 330 is moved forward at the set moving speed. When the pressure of the screw 330 exceeds the set pressure, the screw 330 is moved forward at the moving speed lower than the set moving speed so that the pressure of the screw 330 becomes equal to or lower than the set pressure for the purpose of protecting the mold.

Note that, after the position of the screw 330 reaches the V/P switching position in the filling step, the screw 330 may be temporarily suspended at the V/P switching position, and then the V/P switching may be performed. Immediately before the V/P switching, the screw 330 may be moved forward and backward at a very low speed instead of suspending the screw 330. Further, the screw position detector that detects the position of the screw 330 and the screw moving speed detector that detects the moving speed of the screw 330 are not limited to the injection motor encoder 351, and general detectors can be used.

In the pressure holding step, the injection motor 350 is driven to push the screw 330 forward, and the pressure of the molding material at the front end of the screw 330 (hereinafter, also referred to as “holding pressure”) is increased. The molding material remaining in the cylinder 310 is pushed toward the mold device 800. This enables replenishing the molding material that is insufficient due to cooling shrinkage in the mold device 800. The holding pressure is detected by using, for example, the load detector 360. The set value of the holding pressure may be changed according to the elapsed time from the start of the pressure holding step. A plurality of holding pressures and a plurality of holding times for holding the holding pressures in the pressure holding step may be set, and may be collectively set as a series of setting conditions.

In the pressure holding step, the molding material in the cavity space 801 inside the mold device 800 is gradually cooled, and when the pressure holding step is completed, the inlet of the cavity space 801 is closed by the solidified molding material. This state is called a gate seal, and the backflow of the molding material from the cavity space 801 is prevented. After the pressure holding step, the cooling step is started. In the cooling step, the molding material in the cavity space 801 is solidified. In order to shorten the molding cycle time, the weighing step may be performed during the cooling step.

The injection device 300 of the present embodiment is of an in-line screw type, but may be of a pre-plasticized type. The pre-plasticized injection device supplies a molding material melted in a plasticizing cylinder to an injection cylinder, and injects the molding material from the injection cylinder into a mold device. In the plasticizing cylinder, a screw is disposed in a rotatable and non-retractable manner, or the screw is arranged in a rotatable and retractable manner. A plunger is disposed in the injection cylinder in a retractable manner.

Further, the injection device 300 of the present embodiment is a horizontal type in which the axial direction of the cylinder 310 is the horizontal direction, but may be a vertical type in which the axial direction of the cylinder 310 is the vertical direction. The mold clamping device combined with the vertical injection device 300 may be a vertical type or a horizontal type. Similarly, the mold clamping device combined with the horizontal injection device 300 may be a horizontal type or a vertical type.

### Moving Device

In the description of the moving device 400, as in the description of the injection device 300, the moving direction (e.g., the X-axis negative direction) of the screw 330 during filling is referred to as the front side, and the moving direction (e.g., the X-axis positive direction) of the screw 330 during weighing is referred to as the rear side.

The moving device 400 moves the injection device 300 forward and backward with respect to the mold device 800. The moving device 400 presses the nozzle 320 against the mold device 800 to generate a nozzle touch pressure. The moving device 400 includes a hydraulic pump 410, a motor 420 as a drive source, a hydraulic cylinder 430 as a hydraulic actuator, and the like.

The hydraulic pump 410 includes a first port 411 and a second port 412. The hydraulic pump 410 is a pump capable of rotating in both directions, and generates a hydraulic pressure by switching the rotation direction of the motor 420 to suck a hydraulic fluid (e.g., oil) from one of the first port 411 and the second port 412 and to discharge the hydraulic fluid from the other. The hydraulic pump 410 is also capable of sucking a hydraulic fluid from the tank and discharging the hydraulic fluid from one of the first port 411 and the second port 412.

The motor 420 operates the hydraulic pump 410. The motor 420 drives the hydraulic pump 410 in a rotational direction and with a rotational torque corresponding to a control signal from the control device 700. The motor 420 may be an electric motor or an electric servo motor.

The hydraulic cylinder 430 includes a cylinder body 431, a piston 432, and a piston rod 433. The cylinder body 431 is fixed to the injection device 300. The piston 432 divides the interior of the cylinder body 431 into a front chamber 435 as a first chamber and a rear chamber 436 as a second chamber. The piston rod 433 is fixed to the fixed platen 110.

The front chamber 435 of the hydraulic cylinder 430 is connected to the first port 411 of the hydraulic pump 410 via the first flow path 401. The hydraulic fluid discharged from the first port 411 is supplied to the front chamber 435 via the first flow path 401, and thus the injection device 300 is pushed forward. The injection device 300 is moved forward, and the nozzle 320 is pressed against the fixed mold 810. The front chamber 435 functions as a pressure chamber that generates a nozzle touch pressure of the nozzle 320 by the pressure of the hydraulic fluid supplied from the hydraulic pump 410.

The rear chamber 436 of the hydraulic cylinder 430 is connected to the second port 412 of the hydraulic pump 410 via the second flow path 402. The hydraulic fluid discharged from the second port 412 is supplied to the rear chamber 436 of the hydraulic cylinder 430 via the second flow path 402, and thus, the injection device 300 is pushed backward. The injection device 300 is moved backward, and the nozzle 320 is separated from the fixed mold 810. In the present embodiment, the moving device 400 includes the hydraulic cylinder 430, but the present disclosure is not limited to this example. For example, instead of the hydraulic cylinder 430, an electric motor and a motion conversion mechanism that converts the rotational motion of the electric motor into the linear motion of the injection device 300 may be used.

### Control Device

The control device 700 is configured by, for example, a computer, and includes a central processing unit (CPU) 701, a storage medium 702 such as a memory, an input interface 703, and an output interface 704 as illustrated in FIGS. 1 and 2. The control device 700 performs various controls by causing the CPU 701 to execute the program stored in the storage medium 702. The control device 700 receives a signal from the outside through the input interface 703 and transmits a signal to the outside through the output interface 704.

The control device 700 repeatedly performs the weighing step, the mold closing step, the pressure increasing step, the mold clamping step, the filling step, the pressure holding step, the cooling step, the pressure decreasing step, the mold opening step, the ejection step, and the like, thereby repeatedly manufacturing a molded article. A series of operations for obtaining a molded article, for example, an operation from the start of a weighing step to the start of the next weighing step is also referred to as a “shot” or a “molding cycle”. The time required for one shot is also referred to as “molding cycle time” or “cycle time”.

One molding cycle includes, for example, a weighing step, a mold closing step, a pressure increasing step, a mold clamping step, a filling step, a pressure holding step, a cooling step, a pressure decreasing step, a mold opening step, and an ejection step in this order. The order here is the order of the start of each step. The filling step, the pressure holding step, and the cooling step are performed during the mold clamping step. The start of the mold clamping step may align with the start of the filling step. The completion of the pressure decreasing step aligns with the start of the mold opening step.

In order to shorten the molding cycle time, a plurality of steps may be performed at the same time. For example, the weighing step may be performed during the cooling step of the previous molding cycle, or may be performed during the mold clamping step. In this case, the mold closing step may be performed at the beginning of the molding cycle. The filling step may be started during the mold closing step. The ejection step may be started during the mold opening step. In a case where an opening-closing valve that opens and closes the flow path of the nozzle 320 is provided, the mold opening step may be started during the weighing step. This is because even if the mold opening step is started during the weighing step, the molding material does not leak from the nozzle 320 as long as the opening-closing valve closes the flow path of the nozzle 320.

One molding cycle may include a step other than the weighing step, the mold closing step, the pressure increasing step, the mold clamping step, the filling step, the pressure holding step, the cooling step, the pressure decreasing step, the mold opening step, and the ejection step.

For example, after the completion of the pressure holding step and before the start of the weighing step, a pre-weighing suck-back step of moving the screw 330 backward to a preset weighing start position may be performed. The pressure of the molding material accumulated in front of the screw 330 before the start of the weighing step can be reduced, and the rapid retraction of the screw 330 at the start of the weighing step can be prevented.

After the completion of the weighing step and before the start of the filling step, a post-weighing suck-back step of moving the screw 330 backward to a preset filling start position (also called “injection start position”) may be performed. The pressure of the molding material accumulated in front of the screw 330 before the start of the filling step can be reduced, and the leakage of the molding material from the nozzle 320 before the start of the filling step can be prevented.

The control device 700 is connected to an operation device 750 that receives an input operation by a user and a display device 760 that displays a screen. The operation device 750 and the display device 760 may be configured by, for example, a touch panel 770 and may be integrated. The touch panel 770 as the display device 760 displays a screen under the control of the control device 700. For example, information such as the settings of the injection molding machine 10 and the current state of the injection molding machine 10 may be displayed on the screen of the touch panel 770. Further, on the screen of the touch panel 770, for example, an operation part such as a button or an input field for receiving an input operation by the user may be displayed. The touch panel 770 as the operation device 750 detects an input operation on the screen by the user and outputs a signal corresponding to the input operation to the control device 700. Thus, for example, the user can perform settings (including input of a setting value) of the injection molding machine 10 by operating the operation part provided on the screen while checking the information displayed on the screen. Further, the user can operate the operation part provided on the screen to cause the injection molding machine 10 to perform an operation corresponding to the operation part. Note that the operation of the injection molding machine 10 may be, for example, an operation (including suspending) of the mold clamping device 100, the ejector device 200, the injection device 300, the moving device 400, or the like. The operation of the injection molding machine 10 may be switching of a screen displayed on the touch panel 770 as the display device 760.

Note that the operation device 750 and the display device 760 of the present embodiment are described as being integrated as the touch panel 770, but may be provided independently. A plurality of operation devices 750 may be provided. The operation device 750 and the display device 760 are disposed on the operation side (Y-axis negative direction) of the mold clamping device 100 (more specifically, the fixed platen 110).

### Management of Material Loss Amount

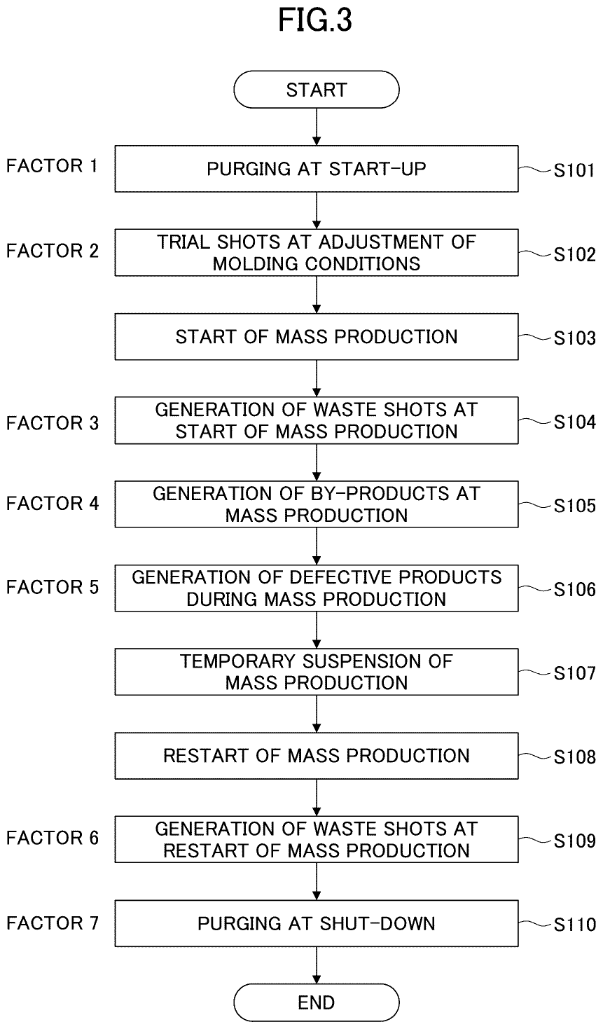

Next, examples of factors of the generation of the material loss from the start-up to the shut-down of the injection molding machine 10 will be described with reference to FIG. 3. The material loss amount is an amount of resin that does not become a molded article (product), of the amount of resin injected from the injection molding machine 10. The molded article does not contain by-products described below. The by-products are solidified in the internal space of the mold device 800 together with the molded article, and are solidified in a resin passage. The resin passage includes, for example, a sprue and a runner. The by-products are ejected from the mold device 800 by the ejector device 200 together with the molded article.

The material loss is generated by purging (step S101) at the start-up of the injection molding machine 10, trial shots (step S102) at the adjustment of the molding conditions, generation of waste shots (step S104) at the start of mass production, generation of by-products (step S105) at the mass production, generation of defective products (step S106) at the mass production, generation of waste shots (step S109) at the restart of the mass production, and purging (step S110) at the shut-down of the injection molding machine 10.

Hereinafter, steps S101 to S110 illustrated in FIG. 3 will be described. The processing after step S101 illustrated in FIG. 3 is started when the mass production plan of the molded articles is executed. Although not illustrated, after generation of the waste shots (step S109) at the restart of mass production, the generation of by-products (step S105) at the mass production and the generation of defective products (step S106) at the mass production are also performed. Further, although not illustrated, the injection molding machine 10 may be temporarily suspended a plurality of times during the period from the start-up to the shut-down of the injection molding machine 10.

The step S101 includes purging at the start-up of the injection molding machine 10. The start-up of the injection molding machine 10 includes a temperature rise of the cylinder 310. The temperature rise of the cylinder 310 includes raising the temperature of the cylinder 310 to a set temperature at the mass production of the molded articles. Purging is performed after the temperature of the cylinder 310 is raised or during the temperature rise of the cylinder 310. Purging is an operation of discharging the resin inside the cylinder 310 to the outside of the injection molding machine 10. Purging may be performed a plurality of times.

Purging is performed in a state where the nozzle 320 is separated from the mold device 800 in order to prevent the mold device 800 from being filled with molding material from the nozzle 320 provided at the front end of the cylinder 310. The purging includes, for example, an operation of rotating and moving the screw 330 backward by the weighing motor 340 and an operation of moving the screw 330 forward by the injection motor 350. Note that the purging may include an operation in which the weighing motor 340 rotates the screw 330 in a state in which the injection motor 350 prohibits the screw 330 from being moved forward and backward. In addition, in a case where the mold device 800 includes a heater that heats a resin passage (e.g., a sprue and a runner), purging may be performed in a state where the nozzle 320 is in contact with the mold device 800.

The purging amount at the start-up is an example of the material loss amount. The purging amount can be calculated based on a purging condition. For example, the purging amount can be calculated based on at least one of the rotation amount of the weighing motor 340 and the rotation amount of the injection motor 350. Instead of the rotation amount of the injection motor 350, the advancement amount of the screw 330 may be used. The purging amount may be calculated using the cross-sectional area of the cylinder 310, the number of purging operations, and the like. The density of the resin may be further used for the calculation of the purging amount. The purging amount may be calculated by any of the user of the injection molding machine 10, the control device 700 of the injection molding machine 10, and a management apparatus that manages the plurality of control devices 700. The purging amount may be measured by a weighing scale.

The step S102 includes trial shots at the adjustment of molding conditions. The trial shots include actually performing the weighing step, the mold closing step, the pressure increasing step, the mold clamping step, the filling step, the pressure holding step, the cooling step, the pressure decreasing step, the mold opening step, the ejection step, and the like, as in the mass production of the molded articles. The trial shots may be repeatedly performed under different molding conditions until the quality of the molded articles obtained by the trial shots reaches a desired standard. The quality of the molded article is evaluated by at least one of, for example, the size, shape, weight, and color.

The trial shot amount is an example of the material loss amount. The trial shot amount can be calculated based on the molding conditions. For example, the trial shot amount can be calculated based on the cross-sectional area of the cylinder 310, the advancement amount of the screw 330, and the density of the resin. The calculation of the trial shot amount may be performed by any of the user of the injection molding machine 10, the control device 700 of the injection molding machine 10, and the management apparatus that manages the plurality of control devices 700. The trial shot amount may be measured by a weighing scale.

The trial shot amount may be calculated based on the volume of the internal space of the mold device 800 and the density of the resin. The internal space of the mold device 800 includes a resin passage and a cavity space 801 provided at the end of the resin passage. The number of the cavity spaces 801 may be plural, and the resin passage may be branched, and the cavity space 801 may be provided at each end of the plural branches of the resin passage.

The step S103 includes start of mass production of the molded articles. The mass production of the molded articles is started after the start-up of the injection molding machine 10 and the adjustment of the molding conditions are completed. Under the molding conditions after the adjustment, the mass production of molded articles is performed.

The step S104 includes generation of waste shots at the start of mass production. Since the quality of the molded article is not stable immediately after the start of mass production, the molded article obtained by the waste shot may be treated as a defective product. The number of generation times of the waste shots is set in advance.

The amount of waste shots at the start of mass production is an example of the material loss amount. The amount of waste shots can be calculated based on the molding conditions. For example, the amount of waste shots can be calculated based on the cross-sectional area of the cylinder 310, the advancement amount of the screw 330, and the density of the resin. The calculation of the amount of waste shots may be performed by any of the user of the injection molding machine 10, the control device 700 of the injection molding machine 10, and the management apparatus that manages the plurality of control devices 700. The amount of the waste shots may be measured by a weighing scale.

The amount of waste shots at the start of mass production may be calculated based on the volume of the internal space of the mold device 800 and the density of the resin. The internal space of the mold device 800 includes a resin passage and a cavity space 801 provided at the end of the resin passage. The number of the cavity spaces 801 may be plural, and the resin passage may be branched, and the cavity space 801 may be provided at each end of the plural branches.

The step S105 includes generation of by-products during mass production. The by-product is solidified in the internal space of the mold device 800 together with the molded article, and is solidified in the resin passage. The resin passage includes, for example, a sprue and a runner. The by-products are ejected from the mold device 800 by the ejector device 200 together with the molded article.

The amount of by-products generated during mass production is an example of the material loss amount. The amount of by-products generated can be calculated based on the molding conditions. For example, the amount of by-products generated can be calculated from the weight of the resin filling the mold device 800 (e.g., the cross-sectional area of the cylinder 310, the advancement amount of the screw 330, and the density of the resin). Alternatively, the amount of by-products generated may be calculated based on the volume of the resin passage of the mold device 800 and the density of the resin. The calculation of the amount of by-products generated may be performed by any of the user of the injection molding machine 10, the control device 700 of the injection molding machine 10, and the management apparatus that manages the plurality of control devices 700. The amount of by-products generated may also be measured with a weighing scale.

The step S106 includes generation of defective products during mass production. The defective products are products other than non-defective products among the molded articles, and are products of which quality does not reach a desired standard among the molded articles. The quality of the molded article is evaluated by at least one of, for example, the size, shape, weight, and color. An inspection device inspects the quality of the molded article. The molded articles are classified into non-defective products and defective products according to the inspection results.

The amount of defective products generated during mass production is an example of the material loss amount. The amount of defective products can be calculated based on the molding conditions. For example, the amount of defective products generated can be calculated based on the cross-sectional area of the cylinder 310, the advancement amount of the screw 330, the density of the resin, and the weight of the by-products. The amount of defective products may be calculated based on the volume of the cavity space 801 of the mold device 800 and the density of the resin. The calculation of the amount of defective products may be performed by any of the user of the injection molding machine 10, the control device 700 of the injection molding machine 10, and the management apparatus that manages the plurality of control devices 700. The amount of defective products may be measured by a weighing scale.

The step S107 includes a temporary suspension of mass production. The temporary suspension of the mass production is performed, for example, when an operation failure of the injection molding machine 10 or a peripheral device (e.g., a molded article conveying device, a temperature control device of the mold device 800, or the like) occurs, or when a molded article failure occurs. The suspension time is not particularly limited, but is, for example, 10 minutes or less. The step S108 includes restart of mass production. The mass production is restarted after the cause of the temporary suspension is removed.

The step S109 includes generation of waste shots at the restart of mass production. Since the quality of the molded article is not stable immediately after the mass production is restarted, the molded article obtained by the waste shot may be treated as a defective product. The number of generation times of the waste shots is set in advance. The amount of waste shots at the restart of mass production is an example of the material loss amount. The amount of waste shots is obtained in the same manner as the amount of waste shots at the start of mass production.

The step S110 includes purging at the shut-down of the injection molding machine 10. The shut-down of the injection molding machine 10 includes a temperature fall of the cylinder 310. The temperature fall of the cylinder 310 includes decreasing the temperature of the cylinder 310 to the set temperature during standby. Purging is performed before the start of the temperature fall of the cylinder 310 or during the temperature fall of the cylinder 310. The purging amount at the shut-down is an example of the material loss amount, and is obtained in the same manner as the purging amount at the shut-down.

As described above, the material loss amount is an amount of resin that is not molded into a molded article (product), of the amount of resin injected from the injection molding machine 10. Part of the resin that has not been molded into a molded article is crushed by a crusher or the like and recycled as a molding material in some cases. Therefore, the material loss amount does not necessarily correspond to the waste amount. Therefore, in the present embodiment, the waste amount and the recycle amount are separately managed as described later. Therefore, the waste amount can be accurately controlled.

Accurate management of waste amount allows, for example, accurate calculation of CO₂ emissions in Scope 3 Category 5 as defined in the GHG (Greenhouse Gas) Protocol. The CO₂ emissions in Scope 3 Category 5 are the CO2 emissions that can be reduced by reviewing the operation of the injection molding machines 10. It is also possible to accurately calculate the emissions of each greenhouse gas (e.g., CH₄ gas). It is also possible to accurately calculate the total amount by multiplying the emissions of each greenhouse gas by its global warming potential (GWP) and adding those results together. The global warming potential is a coefficient that indicates how many times more greenhouse effect a particular gas has than CO₂.

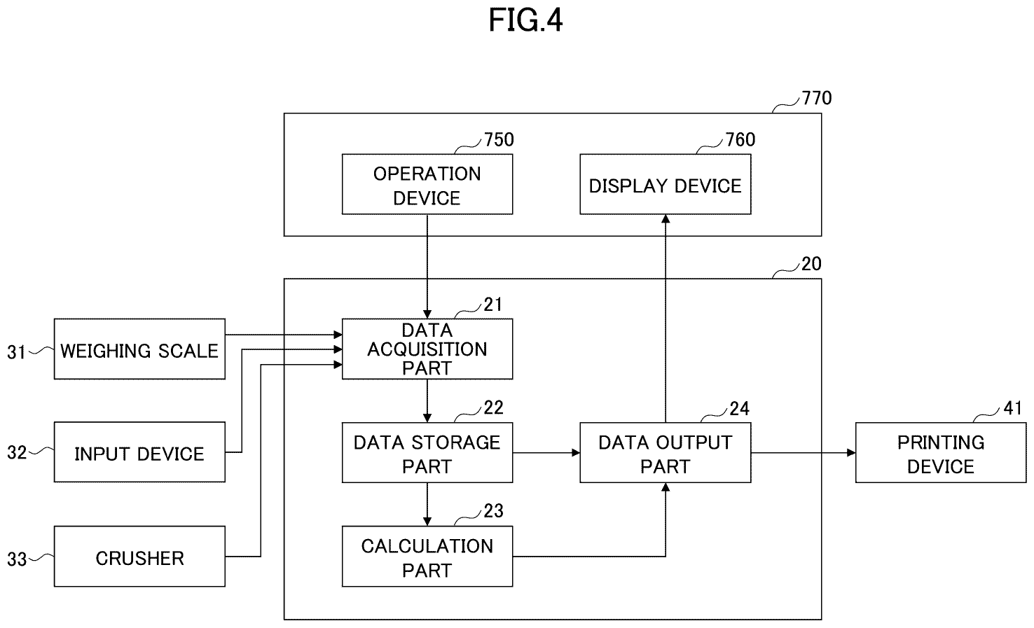

Next, an example of components of a molded article management apparatus 20 will be described with reference to FIG. 4. The molded article management apparatus 20 manages the material loss amount by dividing it into a waste amount and a recycle amount. The molded article management apparatus 20 may be, for example, the control device 700 of the injection molding machine 10. Alternatively, the molded article management apparatus 20 may be the management apparatus that manages the plurality of control devices 700. The management apparatus is a host computer of the control device 700.

The molded article management apparatus 20 includes an electronic circuit such as a CPU, a field programmable gate array (FPGA), or an application specific integrated circuit (ASIC), and executes various control operations described in the present specification by executing instruction s stored in a memory or by designing circuitry for a special purpose.

As illustrated in FIG. 4, the molded article management apparatus 20 includes, for example, a data acquisition part 21, a data storage part 22, a calculation part 23, and a data output part 24. Note that the functional blocks illustrated in FIG. 4 are conceptual and do not necessarily have to be physically configured as illustrated in the figure. All or some of the functional blocks may be configured to be functionally or physically distributed or integrated in arbitrary units.

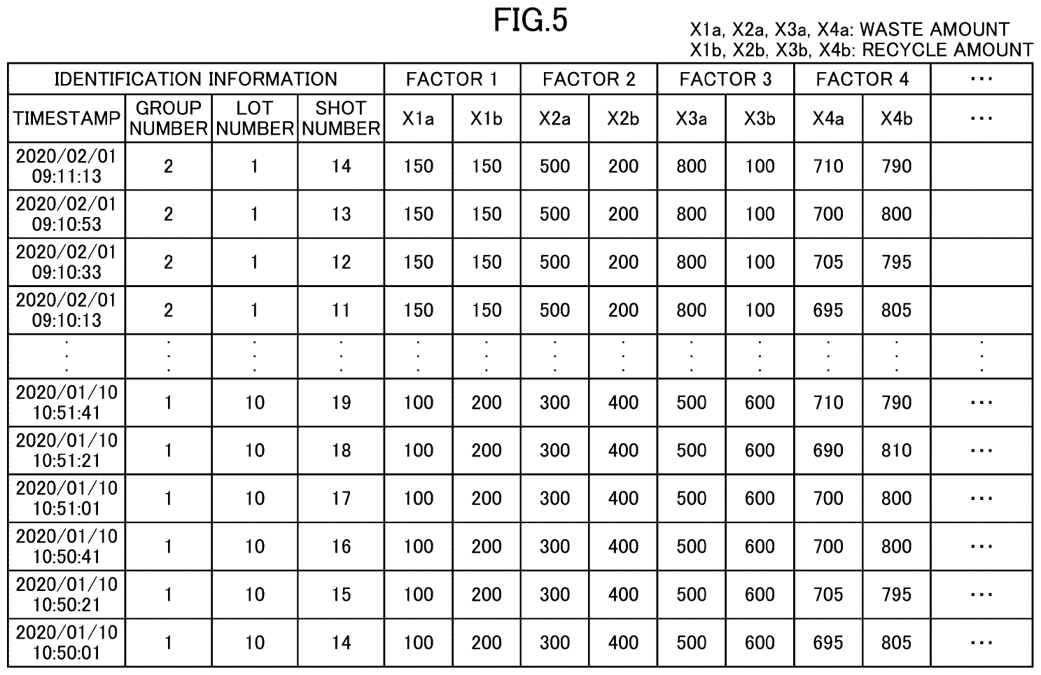

As illustrated in FIG. 5, the data acquisition part 21 acquires identification information of each molded article manufactured by the injection molding machine 10 in association with the material loss amount per molded article manufactured during a set period. The data acquisition part 21 acquires the material loss amount by dividing the material loss amount into the waste amount and the recycle amount. The data storage part 22 stores identification information of each molded article manufactured by the injection molding machine 10 in association with the material loss amount per molded article manufactured during a set period. The data storage part 22 stores the material loss amount by dividing separately the material loss amount into the waste amount and the recycle amount. A calculation part 23 calculates CO₂ emissions based on the waste amount. The data output part 24 outputs at least one of the data stored in the data storage part 22 and the calculation result of the calculation part 23. Hereinafter, the data acquisition part 21, the data storage part 22, the calculation part 23, and the data output part 24 will be described in detail.

The data acquisition part 21 acquires data about each mold manufactured by the injection molding machine 10. The identification information of the molded article is acquired from the control device 700 of the injection molding machine 10 or the like. As illustrated in FIG. 5, the identification information of the molded article preferably includes identification information of a group to which the molded article belongs, identification information of a lot to which the molded article belongs, and identification information of a shot of the molded article. The group to which the molded article belongs is classified according to, for example, a production plan or a period from the start-up to the shut-down of the injection molding machine 10. The identification information of a shot includes, for example, at least one of the date-and-time and the shot number.

The data acquisition part 21 acquires the material loss amount per molded article manufactured during the set period by dividing the material loss amount into the waste amount and the recycle amount. The waste amount can be accurately managed by dividing the material loss amount into the waste amount and the recycle amount. As a result, for example, the CO₂ emissions in Scope 3 Category 5 defined in the GHG (greenhouse effect gas) protocol can be accurately calculated.

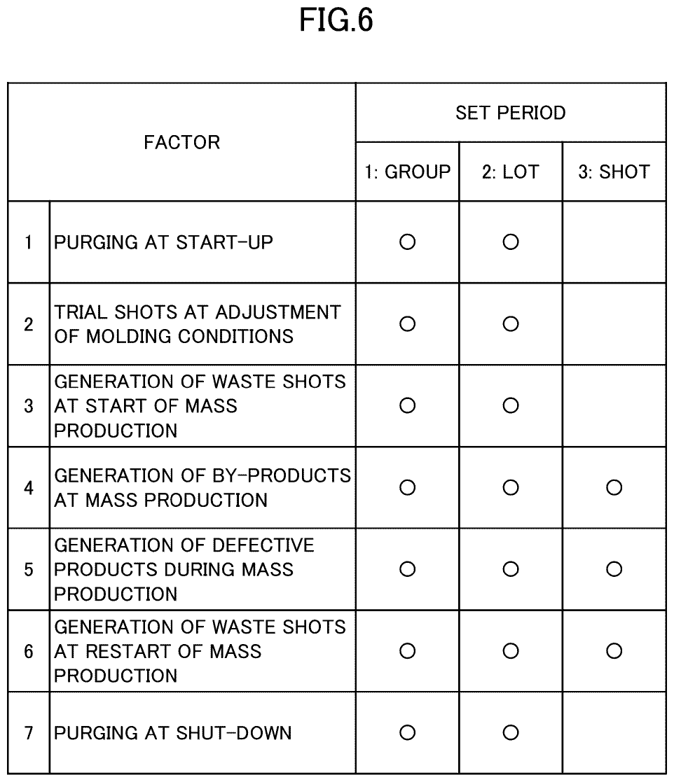

As illustrated in FIG. 6, a set period is determined according to factors. In FIG. 6, ◯ indicates that the set period can be adopted. The set period is determined using the operation device 750, the input device 32, or the like. The operation device 750 is a part of the injection molding machine 10, whereas the input device 32 is provided separately from the injection molding machine 10. In FIG. 5, a set period 1 is adopted as a set period for the factors 1 to 3, and the set period 3 is adopted as the set period for the factor 4.

The material loss amount, the waste amount, or the recycle amount generated during the set period is divided by the number of molded articles manufactured during the set period, and thus the material loss amount, the waste amount, or the recycle amount per molded article is obtained. Here, the molded articles may include only non-defective products and may not include defective products.

The set period 1 is a period from the start of execution of the production plan of the molded article to the end of the execution. The set period 1 may be a period from the start-up to the shut-down of the injection molding machine 10. The injection molding machine 10 may be started and stopped a plurality of times between the start and the end of the execution of the production plan of the molded article.

The set period 2 is a period for manufacturing a lot including a plurality of molded articles. The number of molded articles constituting one lot is determined in advance in the production plan. The number of molded articles constituting one lot is smaller than the planned number of production. A plurality of lots may be manufactured during the period from the start-up to the shut-down of the injection molding machine 10.

The set period 3 is a period for manufacturing an individual molded article. That is, the set period 3 is a period of one shot.

The set period is determined in advance, but may be changeable using the operation device 750 or the input device 32 of the injection molding machine 10. In order to enable the set period to be changed, the identification information of the molded article preferably includes identification information of a group to which the molded article belongs, identification information of a lot to which the molded article belongs, and identification information of a shot of the molded article as illustrated in FIG. 5.

The data acquisition part 21 may acquire the material loss amount by dividing the material loss amount into the waste amount and the recycle amount, according to factors of the material loss amount. The waste amount and the recycle amount can be managed according to the factors, and a factor to be solved for reducing the waste amount can thus be specified. Further, when the waste amount and the recycle amount are managed according to the factors, the waste amount and the recycle amount can be easily corrected when the waste which is scheduled to be discarded is recycled later. This is because the recycling of the material which is originally to be discarded occurs for each factor. For example, the resin lumps generated by purging are larger in size and more difficult to crush than the molded article rejects and by-products. However, the improvement of the crusher 33 may enable the crushing of the resin mass generated by purging.

The material loss amount, the waste amount or the recycle amount is measured by a weighing scale 31. Alternatively, any of the user of the injection molding machine 10, the control device 700 of the injection molding machine 10, and the management apparatus that manages the plurality of control devices 700 calculates the material loss amount, the waste amount, or the recycle amount. The user of the injection molding machine 10 calculates the material loss amount, the waste amount, or the recycle amount, and inputs the calculation result to the operation device 750. The input device 32 may be used instead of the operation device 750.

The data acquisition part 21 acquires the material loss amount, the waste amount, or the recycle amount from the weighing scale 31. Alternatively, the data acquisition part 21 may acquire the material loss amount, the waste amount, or the recycle amount. The information may be acquired from the operation device 750 of the injection molding machine 10, the control device 700 of the injection molding machine 10, or the management apparatus that manages the plurality of control devices 700. The data acquisition part 21 may acquire the recycle amount from the crusher 33. The recycle amount can be estimated from the operation time of the crusher 33 and the like. The waste amount can also be calculated as the difference between the material loss amount and the recycle amount.

As illustrated in FIG. 5, the data storage part 22 stores identification information of each molded article manufactured by the injection molding machine 10 in association with the material loss amount acquired by the data acquisition part 21. As illustrated in FIG. 5, the data storage part 22 may directly associate the identification information with the material loss amount in one list. However, the data storage part 22 may include a first storage part that stores identification information and a second storage part that stores a material loss amount, and may further include a third storage part that stores information that associates the identification information stored in the first storage part with the material loss amount stored in the second storage part.

The data storage part 22 stores the material loss amount per molded article manufactured during the set period, divided into the waste amount and the recycle amount. The waste amount can be accurately managed by managing the material loss amount separately for the waste amount and the recycle amount. As a result, for example, the CO₂ emissions in Scope 3 Category 5 defined in the GHG (greenhouse effect gas) protocol can be accurately calculated.

The data storage part 22 may divide the material loss amount into a waste amount and a recycle amount according to factors of the material loss amount, and store the waste amount and the recycle amount according to the factors. The waste amount and the recycle amount can be managed according to the factors, and a factor to be solved when reducing the waste amount can thus be specified. Further, when the waste amount and the recycle amount are managed for each factor, the waste amount and the recycle amount can be easily corrected when the waste which is scheduled to be discarded is recycled later. This is because the recycling of the material which is originally to be discarded occurs for each factor.

The calculation part 23 calculates the CO₂ emissions based on the waste amount stored in the data storage part 22. For example, the calculation part 23 calculates the CO₂ emissions in Scope 3 Category 5 defined in the GHG (greenhouse effect gas) protocol. The calculation part 23 can also calculate the emissions of each of the greenhouse gases (e.g., CH4 gas). The calculation part 23 calculates the emissions of each greenhouse gas. The calculation part 23 can also calculate the total amount by multiplying the emissions of each greenhouse gas by its global warming potential (GWP) and adding those results together.

The calculation part 23 calculates the CO₂ emissions by multiplying the waste amount by the CO₂ emissions per unit waste amount, for example. The CO₂ emissions per unit waste amount are obtained in advance based on the previous record and the like, and are stored in the data storage part 22 in advance. The CO₂ emissions per unit waste amount may be acquired from the resin manufacturer. Examples of the acquisition method include the Internet and an input device that allows the user to input a numerical value. The CO₂ emissions per unit waste amount may be prepared for each composition of resin.

The molded article management apparatus 20 may manage composition information of resin, identification information of the molded article, the material loss amount, the waste amount, and the recycle amount in association with each other. The composition information of the resin can be acquired from the operation device 750 of the injection molding machine 10, the control device 700 of the injection molding machine 10, or the management apparatus that manages the plurality of control devices 700. The input device 32 may be used instead of the operation device 750.

The calculation part 23 may calculate the CO₂ emissions corresponding to the total waste amount per molded article, or may calculate the CO₂ emissions or the like for each factor of the waste amount. By solving the factor for each factor, the CO₂ emissions that can be reduced can be identified. In addition, recycling of the material, which is originally scheduled to be discarded occurs on a factor-by-factor basis.

The data output part 24 outputs at least one of the data stored in the data storage part 22 and the calculation result of the calculation part 23. As the output device, for example, a display device 760 is used. That is, the data stored in the data storage part 22 and the calculation result of the calculation part 23 may be displayed on the screen of the display device 760. As the output device, a display device provided separately from the injection molding machine 10 or a printing device 41 may be used.

The embodiment of the molded article management apparatus according to the present disclosure has been described above, but the present disclosure is not limited to the above-described embodiment and the like. Various changes, modifications, substitutions, additions, deletions, and combinations are possible within the scope of the claims. Such modifications are also included in the technical scope of the present disclosure.

What is claimed is:

1. A molded article management apparatus comprising:
a processor; and
a memory storing instructions that cause the processor to execute a process, the process including
storing identification information of each molded article manufactured by an injection molding machine in association with a material loss amount per molded article manufactured during a set period, wherein
the material loss amount is an amount of resin that does not become the molded article, of an amount of resin injected from the injection molding machine during the set period, and
the storing includes dividing the material loss amount into a waste amount and a recycle amount and storing the waste amount and the recycle amount.

2. The molded article management apparatus according to claim 1, wherein the storing includes dividing the material loss amount into the waste amount and the recycle amount and storing the waste amount and the recycle amount, according to factors of the material loss amount.

3. The molded article management apparatus according to claim 2, wherein the set period is determined according to the factors.

4. The molded article management apparatus according to claim 3, wherein the set period is a period from a start to an end of execution of a production plan of the molded article, a period from start-up to shut-down of the injection molding machine, a period of manufacturing a lot including a plurality of molded articles, or a period of manufacturing each of the molded articles.

5. The molded article management apparatus according to claim 1, wherein the process further comprises:
calculating CO₂ emissions based on the stored waste amount.
